(19) United States
(12) Patent Application Publication
(10) Pub. No.: US 2019/0191685 A1
(43) Pub. Date: Jun. 27, 2019

(54) RACK TO HOLD FISHING EQUIPMENT

(71) Applicant: Scott Caravella, Port Jervis, NY (US)

(72) Inventor: Scott Caravella, Port Jervis, NY (US)

(21) Appl. No.: 15/850,267

(22) Filed: Dec. 21, 2017

(51) Int. Cl. A01K 97/10

(52) U.S. Cl. CPC A01K 97/10

(57) ABSTRACT

The present invention is a rack to hold fishing equipment with a metal rod; and an adjustable height vertical rod holder that connects to the metal rod on one end. The metal rod connects to a deck mounted base on the other end. The metal rod creates adjustment between the adjustable height vertical rod holder and the deck mounted base to accommodate various size rods.

### BACKGROUND OF THE INVENTION

### Field of the Invention

The present invention is in the field of fishing and boating accessories. More specifically, the present invention is a rack to hold fishing equipment.

### Description of the Related Art

The present invention is a rack that may have a plastic stationary base adjustable metal front rack and a strap. The main purpose of the present invention called the rack is to present a novel fishing rod organizer for boats. Fishing is a popular recreational activity partaken in for leisure or competitive sporting. Many avid fishermen enjoy doing so in watercrafts using multiple fishing rods can take up a lot of deck space, creating tripping hazards and overall difficulties for one to comfortably fish. The rack introduces a fishing rod holder which conveniently maintains fishing rods easily accessible and organized inside boats. The present invention may be comprised of a plastic stationary base intended to be mounted to the deck of a boat. The rack features an adjustable metal front rack which is installed adjacent to the base. Users can place either 6 to 8 rods ends or any suitable number of rod ends within the stationary base, laying the top of the fishing rods in the front rack. The rack additionally offers a strap which can be wrapped over the rods, ideally securing unused fishing rods in order to ensure they do not fall while the boat is in motion. The rack can easily appeal to fishermen, making it possible to be readily available at sporting goods stores and online retailers. The rack is the only product of its kind to present a fishing rod organizer for watercrafts which helps regain deck space. The rack is uniquely designed to hold all types of fishing rods, granting a product that is suitable for any fisherman with a preferred rod and reel used for their favorite fishing activities, in addition to offering complementary colors to match boat colors of any make or model.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a rack to hold fishing equipment, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

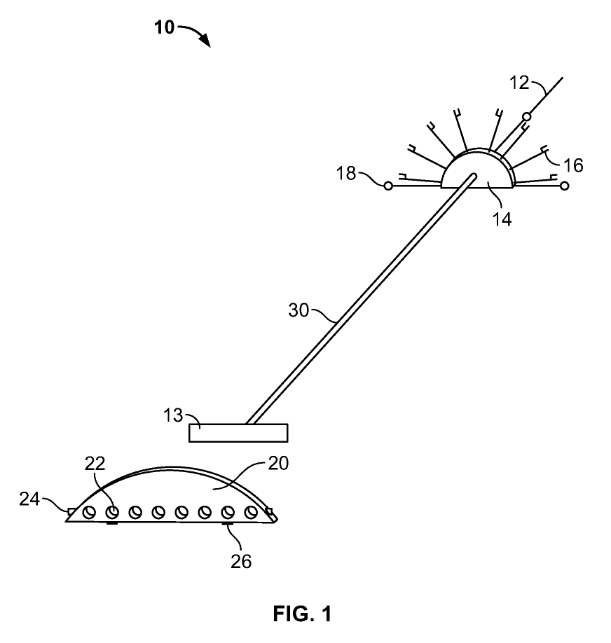

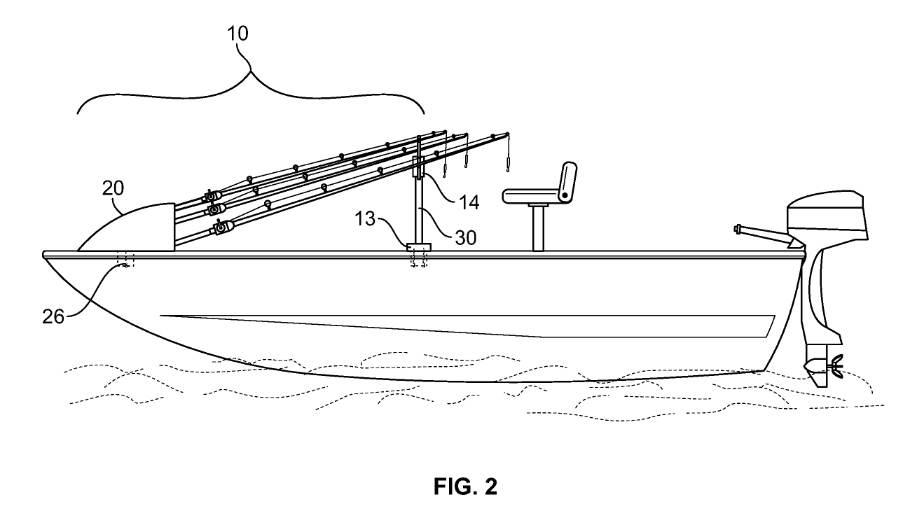

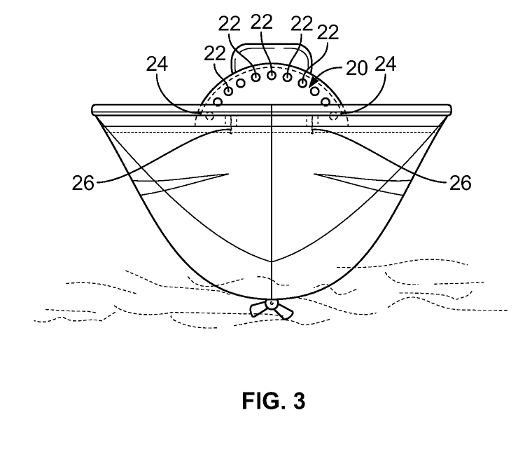

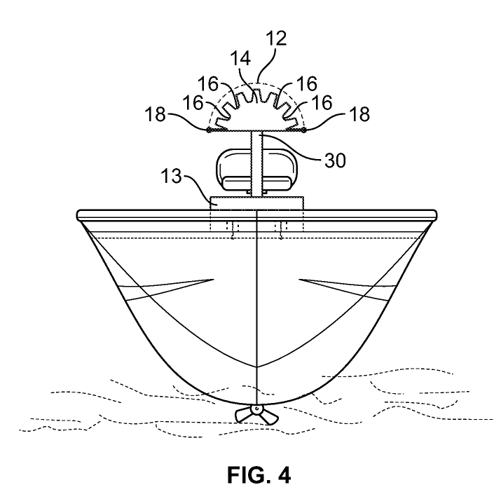

Referring now to FIG. 1, illustrated is rack to hold fishing equipment, in accordance with one embodiment of the present invention. In FIG. 1, illustrated is a rack to hold fishing equipment 10. The present invention is typically mounted on the deck of a fishing boat and will gain space on the boat deck because of the unique design of my present invention to organize fishing rods. A rubber strap clasp 12 is attached to a adjustable height vertical rod holder 14 the adjustable height vertical rod holder 14 is mounted a deck of a boat. A rubber coated rod rack 16 is connected to the adjustable height vertical rod holder 14 the rubber coated rod rack 16 may be made of plastic or metal. A bungee strap clasp 18 is connected to the adjustable height vertical rod holder 14 and is used to secure down fishing rods or rod tips into or on the rubber coated rod rack 16. A rod butt support 20 contains rod butt slots 22 the rod butt support 20 has clasps 24 for rods and a mount 26 to screw into the boat deck. Adjustable metal rod 30 connects adjustable height vertical rod holder 14 and a screw mounted deck base 13 helping secure the rod on the deck.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

1. A rack to hold fishing equipment on a deck of a boat, the rack comprising:
a metal rod;
an adjustable height vertical rod holder disposed on a first end of the metal rod to secure a plurality of fishing equipment on the deck of the boat, such that the adjustable height vertical rod holder adjusts vertically along a length of the metal rod, such that the plurality of fishing equipment are arcuately arranged on the adjustable height vertical rod holder;
a deck mounted base disposed on at least a portion of the deck of the boat to support the metal rod, such that the deck mounted base is disposed on a second end of the metal rod, such that the adjustable height vertical rod holder is vertically adjustable along the metal rod in a first direction toward the deck mounted base, and in a second direction away from the deck mounted base to accommodate the plurality of fishing equipment; and
a rod butt support disposed on at least a portion of the deck of the boat to hold a butt of the plurality of fishing equipment therein, such that the rod butt support is disposed at a distance from the deck mounted base.

2. (canceled)

3. The rack to hold fishing equipment according to claim 1, wherein a rubber coated rod rack is connected to the adjustable height vertical rod holder to hold the plurality of fishing equipment.

4. The rack to hold fishing equipment according to claim 3, wherein a bungee strap clasp is connected to the adjustable height vertical rod holder and is used to secure down the plurality of fishing equipment into or on the rubber coated rod rack.

5. The rack to hold fishing equipment according to claim 1, wherein the rod butt support contains rod butt slots.

6. The rack to hold fishing equipment according to claim 1, wherein each of the plurality of fishing equipment is a fishing rod.
